(19) United States
(12) Patent Application Publication
(10) Pub. No.: US 2021/0246284 A1
(43) Pub. Date: Aug. 12, 2021

(54) SHAPED ARTICLE AND METHOD OF MANUFACTURING THE SAME, PREPREG, AND LAMINATE

(71) Applicant: ZEON CORPORATION, Chiyoda-ku, Tokyo (JP)

(72) Inventor: Ichiro HAZEYAMA, Chiyoda-ku, Tokyo (JP)

(73) Assignee: ZEON CORPORATION, Chiyoda-ku, Tokyo (JP)

(21) Appl. No.: 16/973,424

(22) PCT Filed: Jun. 12, 2019
(86) PCT No.: PCT/JP2019/023270

§ 371 Date: Dec. 9, 2020

(30) Foreign Application Priority Data
Jun. 27, 2018 (JP) 2018-122108

(51) Int. Cl. C08K 5/11; C08J 5/24; B32B 5/02; B32B 15/20; B32B 15/08; B32B 27/12; B32B 27/18; B32B 27/32

(52) U.S. Cl. CPC C08K 5/11; C08J 5/244; B32B 5/02; B32B 15/20; B32B 15/08; B32B 2307/704; B32B 27/18; B32B 27/325; C08J 2345/00; B32B 2307/3065; B32B 2262/101; B32B 27/12

(57) ABSTRACT

Disclosed is a shaped article which comprises a thermoplastic alicyclic structure-containing resin. The shaped article comprises a spherulite having a size of less than 3 μm and has a crystallinity of 20% or more and 70% or less.

### TECHNICAL FIELD

The present disclosure relates to a shaped article and a method of manufacturing the same, a prepreg, and a laminate. In particular, the present disclosure relates to a shaped article comprising a thermoplastic alicyclic structure-containing resin, a method of manufacturing the same, and a prepreg and a laminate which comprise a thermoplastic alicyclic structure-containing resin.

### BACKGROUND

Electronic devices that use high-speed transmission signals or high-frequency signals are required to include a printed circuit board, which comprises a board made of material with low dielectric constant and low dielectric loss. Copper clad laminates have been commonly used as such printed circuit boards. A copper clad laminate is obtained by disposing a metal layer such as copper foil on both sides of a prepreg (product formed by impregnating a base material such as a glass cloth with a thermosetting resin) and curing the thermosetting resin by heat pressing or other methods. However, while thermosetting resins have excellent heat resistance and shape accuracy, their relatively large dielectric constant and dielectric loss have been problematic.

Alicyclic structure-containing resins tend to have a low dielectric constant and a low dielectric loss. In particular, crystalline alicyclic structure-containing resins have excellent heat resistance for their relatively high melting points, making them promising board materials for printed circuit boards. Board materials with high heat resistance are advantageous for use in printed circuit boards because the reflow soldering process can be suitably implemented.

Thus, recently, techniques have been developed for using thermoplastic alicyclic structure-containing resins as board materials.

For example, PTL 1 discloses a technique for forming a printed circuit board using a crystalline thermoplastic alicyclic structure-containing resin as a board material. The printed circuit board obtained in accordance with the teachings of PTL 1 is excellent in the balance between heat shock test resistance and transmission characteristics and can be used particularly suitably for transmission of high-frequency signals.

### CITATION LIST

### Patent Literature

PTL 1: JP2017170735A

### SUMMARY

### Technical Problem

Board materials used in printed circuit boards are required to have excellent strength in addition to sufficient heat resistance. However, the crystalline thermoplastic alicyclic structure-containing resins described in PTL 1 have room for improvement in terms of heat resistance and strength.

Accordingly, an object of the present disclosure is to provide a shaped article comprising a thermoplastic resin having excellent heat resistance and strength, and a method of manufacturing the same.

Another object of the present disclosure is to provide a prepreg comprising a thermoplastic resin having excellent heat resistance and strength.

Still another object of the present disclosure is to provide a laminate comprising a resin layer made of a thermoplastic resin having excellent heat resistance and strength.

### Solution to Problem

The inventor conducted extensive studies with the aim of solving the problem set forth above. The inventor has established that, when forming a shaped article using a thermoplastic alicyclic structure-containing resin, regulation of the size of spherulites formed from the thermoplastic alicyclic structure-containing resin makes it is possible to allow the resulting shaped article etc. to have a high heat resistance and a high strength at the same time, and thus completed the present disclosure.

Specifically, the present disclosure aims to advantageously solve the problem set forth above, and a shaped article disclosed herein comprises a thermoplastic alicyclic structure-containing resin, wherein the shaped article comprises a spherulite having a size of less than 3 μm and has a crystallinity of 20% or more and 70% or less. When a shaped article which comprises a thermoplastic alicyclic structure-containing resin has a spherulite size and a crystallinity which fall within the respective ranges set forth above, it is possible to achieve high heat resistance and high strength at the same time.

The “crystallinity” can be measured by the method described in Examples using an X-ray diffractometer and the “spherulite size” can be measured by the method described in Examples.

In the disclosed shaped article, it is preferred that the thermoplastic alicyclic structure-containing resin have a melting point of 200° C. or higher. When the melting point of the thermoplastic alicyclic structure-containing resin is 200° C. or higher, it is possible to further increase the heat resistance of the shaped article.

The “melting point” of the thermoplastic alicyclic structure-containing resin can be measured by the method described in Examples using a differential scanning calorimeter.

The disclosed shaped article may further comprise at least one of a filler, a flame retardant, and an antioxidant. When a shaped article comprises any of these components, the shaped article may have desired attributes.

The present disclosure aims to advantageously solve the problem set forth above, and a prepreg disclosed herein comprises a resin part and a base material adjacent to the resin part, wherein the resin part comprises a thermoplastic alicyclic structure-containing resin, the resin part has a crystallinity of 20% or more and 70% or less, and the resin part comprises a spherulite having a size of less than 3 μm. When the spherulite size and the crystallinity of the resin part in a prepreg which comprises a thermoplastic alicyclic structure-containing resin fall within the respective ranges set forth above, the prepreg has excellent heat resistance and strength.

In the disclosed prepreg, it is preferred that the thermoplastic alicyclic structure-containing resin have a melting point of 200° C. or higher. When the melting point of the thermoplastic alicyclic structure-containing resin is 200° C. or higher, it is possible to further increase the heat resistance of the prepreg.

In the disclosed prepreg, the resin part may further comprise at least one of a filler, a flame retardant, and an antioxidant. When the prepreg comprises any of these components, the prepreg may have desired attributes.

The present disclosure aims to advantageously solve the problem set forth above, and a laminate disclosed herein comprises a resin layer and a metal layer laminated directly adjacent to at least one side of the resin layer, wherein the resin layer comprises a thermoplastic alicyclic structure-containing resin, the resin layer has a crystallinity of 20% or more and 70% or less, and the resin layer comprises a spherulite having a size of less than 3 μm. When the spherulite size and the crystallinity of the resin layer in a laminate which comprises a thermoplastic alicyclic structure-containing resin in the resin layer fall within the respective ranges set forth above, the laminate has excellent heat resistance and strength.

In the disclosed laminate, the resin layer may further comprise at least one of a filler, a flame retardant, and an antioxidant. When the laminate comprises any of these components, the laminate may have desired attributes.

The present disclosure aims to advantageously solve the problem set forth above, and a method of manufacturing a shaped article disclosed herein comprises a crystallization step wherein a pre-shaped article comprising a thermoplastic alicyclic structure-containing resin is heat-pressed at a temperature equal to or higher than a melting point Tm (° C.) of the thermoplastic alicyclic structure-containing resin and then rapidly cooled to a crystallization temperature Tc (° C.) of the thermoplastic alicyclic structure-containing resin to crystallize the thermoplastic alicyclic structure-containing resin. With this manufacturing method, it is possible to efficiently manufacture a shaped article having excellent heat resistance and strength.

In the disclosed method of manufacturing a shaped article, it is preferred that the cooling time from the melting point Tm (° C.) to the crystallization temperature Tc (° C.) upon rapid cooling in the crystallization step be 1 minute or less. By using such a cooling condition in the crystallization step, it is possible to favorably control the crystallization of the thermoplastic alicyclic structure-containing resin.

### Advantageous Effect

According to the present disclosure, it is possible to provide a shaped article which comprises a thermoplastic resin having excellent heat resistance and strength, and a method for producing the same.

According to the present disclosure, it is also possible to provide a prepreg which comprises a thermoplastic resin having excellent heat resistance and strength.

According to the present disclosure, it is also possible to provide a laminate which comprises a thermoplastic resin layer having excellent heat resistance and strength.

### BRIEF DESCRIPTION OF THE DRAWINGS

In the accompanying drawings:

FIG. 1 depicts an atomic force microscope image of a shaped article according to an example of the present disclosure;

FIG. 2 depicts a temperature profile and a pressure profile when the crystallization step (2) is carried out in Example 1 etc.;

FIG. 3 depicts a temperature profile when a reflow test is carried out in Example 1 etc.;

FIG. 4 depicts a temperature profile and a pressure profile when the crystallization step (2) is carried out in Example 2;

FIG. 5 depicts a temperature profile when a reflow test is carried out in Example 2;

FIG. 6 depicts a temperature profile and a pressure profile when the crystallization step (2) is carried out in Example 4;

FIG. 7 depicts a temperature profile and a pressure profile when the crystallization step (2) is carried out in Comparative Example 2 etc.; and

FIG. 8 depicts a temperature profile and a pressure profile when the crystallization step (2) is carried out in Comparative Example 3.

### DETAILED DESCRIPTION

Hereinafter, embodiments of the present the present disclosure will be described in detail with reference to the drawings. The disclosed shaped article can be suitably used when forming a printed circuit board. In particular, the disclosed shaped article, prepreg and laminate can be suitably used when forming a printed circuit board suitable for an electronic device that uses high-speed transmission signals or high-frequency signals. The disclosed shaped article can be efficiently manufactured by the disclosed method of manufacturing a shaped article.

Each will be described in detail below.

(Shaped Article)

The disclosed shaped article comprises a thermoplastic alicyclic structure-containing resin. Further, the disclosed shaped article comprises a spherulite having a size of less than 3 μm and has a crystallinity of 20% or more and 70% or less. The disclosed shaped article has excellent strength and heat resistance because it has a crystallinity that falls within the range set forth above and comprises a spherulite of a predetermined size.

<Resin>

The resin used for the disclosed shaped article is required to include at least one thermoplastic alicyclic structure-containing resin. A plurality of different thermoplastic alicyclic structure-containing resins may be included. Optionally, resins other than thermoplastic alicyclic structure-containing resins which are different from additional components and additives described later may also be included. When the disclosed shaped article comprises a thermoplastic alicyclic structure-containing resin, the shaped article can exhibit good adhesion.

The thermoplastic alicyclic structure-containing resin needs to be crystalline. The term “crystalline” as used herein for a resin refers to the resin's property of having a melting point that is detectable using a differential scanning calorimeter (DSC) under the conditions described in Examples. It should be noted that such a property is determined by stereoregularity of polymer chains. The term “thermoplastic” as used herein for a resin refers to the resin's property of repeating cycles of becoming soft when heated and becoming hard when cooled.

Examples of thermoplastic alicyclic structure-containing resins used herein include cycloolefin polymers having an alicyclic structure in their molecule and thermoplastic properties. Such resins can be those known in the art, e.g., syndiotactic stereoregular hydrogenated dicyclopentadiene ring-opened polymers described in WO2012/033076, isotactic stereoregular hydrogenated dicyclopentadiene ring-opened polymers described in JP2002249553A, and hydrogenated norbornene ring-opened polymers described in JP2007016102A. From the viewpoint of productivity etc., syndiotactic stereoregular hydrogenated dicyclopentadiene ring-opened polymers are preferred as the resin.

Syndiotactic stereoregular hydrogenated dicyclopentadiene ring-opened polymers can be suitably synthesized according to the method disclosed in JP2017170735A. The term “syndiotactic stereoregular” means that the proportion of racemo diads as measured in accordance with ¹³C-NMR described in Examples is 51% or more. The proportion of racemo diads in the syndiotactic stereoregular hydrogenated dicyclopentadiene ring-opened polymers is preferably 60% or more, and more preferably 70% or more.

«Preferred Attributes of Thermoplastic Alicyclic Structure-Containing Resin»

### [Melting Point]

The thermoplastic alicyclic structure-containing resin preferably has a melting point of 200° C. or higher, more preferably 220° C. or higher, even more preferably 240° C. or higher, and still even more preferably 260° C. or higher, but preferably 350° C. or lower, more preferably 320° C. or lower, and even more preferably 300° C. or lower. When the melting point is equal to or higher than the lower limit, it is possible to favorably increase the heat resistance of the shaped article. When the melting point is equal to or lower than the above upper limit, it is possible to favorably increase the formability of the shaped article. The melting point of the thermoplastic alicyclic structure-containing resin can be adjusted for example by controlling the stereoregularity and percent hydrogenation etc. when synthesizing a polymer constituting the resin.

[Crystallization Temperature]

The thermoplastic alicyclic structure-containing resin preferably has a crystallization temperature that is equal to or higher than the glass-transition temperature Tg, and more preferably equal to or higher than Tg+10° C., but preferably equal to or lower than Tg+50° C. When the crystallization temperature falls within the range set forth above, it is possible to control crystal growth by controlling the cooling temperature and cooling rate. The crystallization temperature of the thermoplastic alicyclic structure-containing resin can be adjusted for example by controlling stereoregularity.

### [Glass-Transition Temperature]

From the viewpoint of heat resistance, the thermoplastic alicyclic structure-containing resin preferably has a glass-transition temperature of 80° C. or higher, and more preferably 90° C. or higher. On the other hand, the glass-transition temperature of the thermoplastic alicyclic structure-containing resin is preferably 200° C. or lower from the viewpoint of formability. From the viewpoint of making temperature control relatively easy during the crystallization step or other steps, the glass-transition temperature is more preferably 150° C. or lower. The “glass-transition temperature” can be measured in accordance with the method described in Examples using a differential scanning calorimeter. The glass-transition temperature of the thermoplastic alicyclic structure-containing resin can be adjusted for example by controlling the compositional ratios of a plurality of thermoplastic alicyclic structure-containing resins.

[Percent Hydrogenation]

In the thermoplastic alicyclic structure-containing resin, the percent hydrogenation of carbon-carbon double bonds contained in the main chain of the thermoplastic alicyclic structure-containing resin is preferably 95% or more, and more preferably 99% or more. Further, when the thermoplastic alicyclic structure-containing resin also has carbon-carbon double bonds in positions other than the main chain, the percent hydrogenation of the total carbon-carbon double bonds contained in the main chain and in the other positions is preferably 95% or more, and more preferably 99% or more. The higher the percent hydrogenation, the higher the heat resistance of the resulting shaped article. The “percent hydrogenation” is a value based on mole that can be calculated by ¹H-NMR spectroscopy. The percent hydrogenation of the thermoplastic alicyclic structure-containing resin can be adjusted by controlling the hydrogenation conditions used to hydrogenate the resin's polymer.

«Spherulite of Resin»

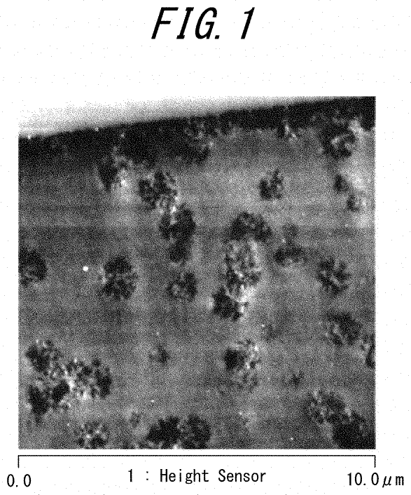

The disclosed shaped article is required to comprise a spherulite with a size of less than 3 μm. When the size of the spherulite included in the shaped article is less than 3 μm, the shaped article has higher strength and higher heat resistance. Preferably, the spherulite size is 2.2 μm or less because the strength of the shaped article can be further increased. The phrase “the shaped article comprises a spherulite with a size of less than 3 μm” means, in other words, that when the shaped article comprises a plurality of spherulites, the size of the largest spherulite among the plurality of spherulites is less than 3 μm. FIG. 1 is an exemplary atomic force microscopic image of a cross section of a shaped article which comprises a plurality of spherulites, among which the largest is about 1 μm or less in size. The dark regions distributed in the displayed field corresponds to spherulites. The spherulite size can be obtained by directly measuring the size of a crystal observed as a spherulite in an atomic force microscopic image.

A spherulite consists of a folded structure of molecular chains of a resin's polymer and occurs in the process of cooling a molten resin. The spherulite size varies depending primarily on the manner in which the temperatures changes during the resin cooling process. Accordingly, by setting the time from melting temperature to crystallization temperature to fall within a predetermined period of time in the cooling step of a molten resin as in the disclosed method of manufacturing a shaped article described later, it is possible to efficiently control the spherulite size to fall within the predetermined range described above.

<Additional Components>

In addition to the resin described above, the shaped article preferably comprises at least one of an antioxidant, a filler and a flame retardant as an additional component. When any of these agents are included, it is possible to impart a desired attribute to the shaped article. Further, the shaped article may optionally comprise various additives other than the additional components described above. Such additives include crystal nucleating agents, flame retardant aids, colorants, antistatic agents, plasticizers, ultraviolet absorbers, light stabilizers, near-infrared absorbers, and lubricants.

Examples of antioxidants include phenol antioxidants, phosphorous antioxidants, and sulfur antioxidants. One type alone or two or more types may be used. When the shaped article comprises an antioxidant, it can be suitably used for forming a printed circuit board.

Examples of phenol antioxidants include 3,5-di-t-butyl-4-hydroxytoluene, dibutyl hydroxytoluene, 2,2′-methylenebis(6-t-butyl-4-methylphenol), 4,4′-butylidenebis(6-t-butyl-3-methylphenol), 4,4′-thiobis(6-t-butyl-3-methylphenol), α-tocopherol, 2,2,4-trimethyl-6-hydroxy-7-t-butylchroman, and tetrakis[methylene-3-(3′,5′-di-t-butyl-4′-hydroxyphenyl)propionate]methane.

Examples of phosphorous antioxidants include distearylpentaerythritol diphosphite, bi s(2,4-diteributylphenyl)pentaerythritol diphosphite, tris(2,4-diteributylphenyl)phosphite, tetrakis(2,4-diteributylphenyl)4,4′-biphenyl diphosphite, and trinonylphenyl phosphite.

Examples of sulfur antioxidants include distearyl thiodipropionate and dilauryl thiodipropionate.

Examples of fillers include inorganic and organic fillers. Inorganic fillers include metal hydroxide fillers such as magnesium hydroxide, calcium hydroxide, and aluminum hydroxide; metal oxide fillers such as magnesium oxide, titanium dioxide, zinc oxide, aluminum oxide, and silicon dioxide (silica); metal chloride fillers such as sodium chloride and calcium chloride; metal sulfate fillers such as sodium sulfate and sodium hydrogen sulfate; metal nitrate fillers such as sodium nitrate and calcium nitrate; metal phosphate fillers such as sodium hydrogen phosphate and sodium dihydrogen phosphate; metal titanate fillers such as calcium titanate, strontium titanate, and barium titanate; metal carbonate fillers such as sodium carbonate and calcium carbonate; carbide fillers such as boron carbide and silicon carbide; nitride fillers such as boron nitride, aluminum nitride, and silicon nitride; metal particle fillers such as aluminum, nickel, magnesium, copper, zinc and iron particles; silicate fillers such as mica, kaolin, fly ash, and talc; glass fiber; glass powder; carbon black; and so forth. These inorganic fillers may be those surface-treated with silane coupling agents, titanate coupling agents, aluminum coupling agents or other coupling agents known in the art. Examples of organic fillers include particles of organic pigments, polystyrene, nylon, polyethylene, polypropylene, vinyl chloride, various elastomers and other compounds.

Flame retardants that can be used herein include halogen flame retardants and non-halogen flame retardants known in the art. Halogen flame retardants include tris(2-chloroethyl) phosphate, tris(chloropropyl) phosphate, tris(dichloropropyl) phosphate, chlorinated polystyrene, chlorinated polyethylene, highly chlorinated polypropylene, chlorosulfonated polyethylene, hexabromobenzene, decabromodiphenyloxide, bi s(tribromophenoxy)ethane, 1,2-bis(pentabromophenyl)ethane, tetrabromobisphenol S, tetradecabromodiphenoxybenzene, 2,2-bis(4-dichloro-3,5-dibromophenylpropane), and pentabromotoluene.

<Amounts of Components in Shaped Article>

The amount of the thermoplastic alicyclic structure-containing resin in the shaped article is usually 50% by mass or more, preferably 60% by mass or more, and more preferably 80% by mass or more, based on 100% by mass of the entire shaped article. The amount of the additional components described above can be determined as appropriate according to the intended purpose, but is usually less than 50% by mass, preferably less than 40% by mass, and more preferably less than 20% by mass, based on 100% by mass of the entire shaped article. When two or more different additional components are used in combination, it is preferred that the total amount of the two or more different additional components fall within the range set forth above.

For example, the amount of an antioxidant is usually 0.001% by mass or more, preferably 0.01% by mass or more, and more preferably 0.1% by mass or more, but usually 5% by mass or less, preferably 4% by mass or less, and more preferably 3% by mass or less, based on 100% by mass of the entire shaped article. The amount of a filler, for example, is usually 5% by mass or more, and preferably 10% by mass or more, but usually 40% by mass or less, and preferably 30% by mass or less. The amount of a flame retardant, for example, is usually 1% by mass or more, and preferably 10% by mass or more, but usually 40% by mass or less, and preferably 30% by mass or less.

<Shape of Shaped Article>

The shaped article can be of any shape that is suitable for the intended application. Preferably, the shaped article is in a sheet shape. The term “sheet shape” as used herein means a shape having opposing surfaces spaced apart by a distance corresponding to thickness.

When the shaped article has a sheet shape, its thickness is usually 10 μm or more, and preferably 25 μm or more, but usually 250 μm or less, and preferably 100 μm or less.

<Crystallinity of Shaped Article>

The disclosed shaped article is required to have a crystallinity of 20% or more and 70% or less. When the crystallinity of the shaped article is 20% or more, it has sufficiently high heat resistance. On the other hand, when the crystallinity of the shaped article is 70% or less, it has sufficiently high strength. Further, for much higher heat resistance, the crystallinity of the shaped article is preferably 30% or more.

When the crystallinity of the shaped article is high, it shows excellent insulation at high temperatures, e.g., at above 100° C., and thus can be suitably used as a constituent material of an electronic component to be provided in an electronic device that uses high-speed transmission signals and high-frequency signals, etc.

The crystallinity of the shaped article can be controlled for example by adjusting the temperature when converting the resin into molten state or the time from melting point to crystallization temperature in the step of cooling the molten resin.

(Method of Manufacturing Shaped Product)

The disclosed method of manufacturing a shaped article comprises a crystallization step (also referred to as “crystallization step (2)”) wherein a pre-shaped article comprising a thermoplastic alicyclic structure-containing resin is heat-pressed at a temperature equal to or higher than the melting point Tm (° C.) of the thermoplastic alicyclic structure-containing resin and then rapidly cooled to the crystallization temperature Tc (° C.) of the thermoplastic alicyclic structure-containing resin to crystallize the thermoplastic alicyclic structure-containing resin. In the crystallization step, the pre-shaped article is heat-pressed at a temperature equal to or higher than the melting point Tm (° C.) and then rapidly cooled to the crystallization temperature Tc (° C.), whereby the size of a spherulite of the resin contained in the obtained shaped article and the crystallinity of the shaped article can be efficiently controlled to desired values. The disclosed manufacturing method may optionally comprise a step (0) of obtaining resin pellets containing a thermoplastic alicyclic structure-containing resin, and a step (1) of melt-molding the resin pellets by heating it to a temperature equal to or higher than the melting point Tm (° C.) of the thermoplastic alicyclic structure-containing resin to afford a pre-shaped article. Each step will be described in detail below.

<Step (0) of Obtaining Resin Pellets>

In the step (0) of obtaining resin pellets, optional additional components and/or additives are added where necessary to the thermoplastic alicyclic structure-containing resin that meets the attributes described in detail in the section “(Shaped Article)” above and are premixed by conventional methods to afford a premix. The premix is then introduced into a twin-screw extruder or other known mixer and molded by melt extrusion or other known molding method to afford a shaped article in the form of a strand. The strand is then cut into resin pellets by a cutter such as a strand cutter. The temperature upon premixing is not particularly limited and may be 0° C. or higher and lower than the melting point Tm (° C.) of the thermoplastic alicyclic structure-containing resin. In addition, the temperature at which the premix is mixed in a twin-screw extruder or other mixer may be equal to or higher than the melting point Tm (° C.) of the thermoplastic alicyclic structure-containing resin and equal to or lower than Tm+100(° C.).

<Step (1) of Obtaining Pre-Shaped Article>

In the step (1) of obtaining a pre-shaped article, the resin pellets obtained in the step (0) are melt-molded by heating them to a temperature equal to or higher than the melting point Tm (° C.) of the thermoplastic alicyclic structure-containing resin to afford a pre-shaped article. The step (1) is not particularly limited and can be carried out using a device capable of heating resin pellets to a temperature equal to or higher than the melting point Tm (° C.) of the thermoplastic alicyclic structure-containing resin, and a device capable of molding the resin pellets into a desired shape. Suitable molding machines include hot-melt extrusion film making machines equipped with a T die. Molding can be carried out by any method known in the art such as, for example, injection molding, extrusion molding, press forming, blow molding, calendar molding, cast molding, or compression molding. Optionally, stretching treatment may be carried out in the step (1).

The temperature at which the resin pellets are heated may be equal to or lower than Tm+100 (° C.).

<Crystallization Step (2)>

In the crystallization step (2), the pre-shaped article to be pressed is heat-pressed at a temperature equal to or higher than the melting point Tm (° C.) to form a shaped article, and then the shaped article is rapidly cooled to the crystallization temperature Tc (° C.). The crystallization step (2) is not particularly limited and can be carried out using a vacuum press device or the like having a temperature adjusting mechanism. In the crystallization step (2), heating of the pre shaped article may be started after the application of a press pressure to the pre-shaped article, or heating of the pre-shaped article may be started prior to or at the same time as the application of a press pressure to the pre-shaped article. It is preferred that heating of the pre-shaped article be started prior to or at the same time as the application of a press pressure to the pre-shaped article. This is because heat is uniformly transferred from a heating medium with the pre-formed article being pressed, so that temperature uniformity can be maintained. Further, upon rapid cooling of the shaped article, cooling may be started after or at the same time as releasing the application of a press pressure, or cooling may be started prior to releasing the application of a press pressure followed by releasing of the application of the press pressure. It is preferred that cooling of the shaped article be started after or at the same time as releasing the application of a press pressure because the formation of a spherulite can be moderately promoted. When starting the cooling of the shaped article after releasing the application of a press pressure, it is useful to replace the heated heating medium with a cooling medium (i.e., a refrigerant). At this time, the shaped article can be uniformly cooled by temporally stopping the pressing of the shaped article by a press member such as a press plate, replacing the heating medium for heating the press member with a refrigerant to make uniform the temperature of the press member itself, and again pressing the shaped article at a low pressure using the press member.

The heating temperature of the pre-shaped article at the time of heat pressing is required to be equal to or higher than the melting point Tm (° C.), and preferably equal to or higher than the melting point Tm+10 (° C.), but preferably equal to or lower than Tm+100 (° C.), and more preferably equal to or lower than Tm+50 (° C.). The uniformity of the shaped article can be increased by setting the heating temperature to be equal to or higher than the above-mentioned lower limit. When the heating temperature of the pre-shaped article at the time of heat pressing is less than the melting point Tm (° C.), crystallization of the shaped article progresses during heat pressing to cause growth of spherulites. Even when the shaped article is cooled in the subsequent steps, the grown spherulites remain in the shaped article and tend to be breaking points, which may lead to decreases in the strength of the shaped article. When the heating temperature is at the melting point Tm (° C.) or higher, the shaped article can be favorably made amorphous in the heating step. This allows crystallization to be favorably controlled in the subsequent crystallization step. By setting the heating temperature at the above upper limit or less, the crystallinity of the shaped article can be prevented from being excessively increased, so that the strength of the shaped article can be further increased. Because it is only necessary to uniformly dissolve the shaped article for amorphization upon heat pressing, heating at excessively high temperatures is not necessary.

The heating temperature of the pre-shaped article upon heat pressing may be a set temperature of heating means (e.g., a heater as a temperature adjusting mechanism provided in a vacuum press device) used to heat the pre-shaped article, rather than the temperature of the pre-shaped article itself to be heated.

It is preferred that the cooling time from melting point Tm (° C.) to crystallization temperature Tc (° C.) upon rapid cooling be 1 minute or less. This is because it is possible to more effectively prevent excessive increases in spherulite size.

The press pressure is not particularly limited and may be, for example, 1 MPa or more and 10 MPa or less. The shaped article can be favorably obtained at a relatively low press pressure that falls within the pressure range set forth above. When making a prepreg, a laminate etc., to be described later, it is preferred to apply a press pressure that falls within the pressure range set forth above but is slightly higher than that used for making the shaped article, from the viewpoint of increasing adhesion between among components such as resin, base material, and metal. However, even when a press pressure as high as more than 10 MPa has been applied, it does not result in dramatic increases in adhesion. Thus, about 10 MPa is sufficient for the preferred upper limit of the press pressure. In the cooling step, it is preferred to apply a press pressure that is sufficiently lower that applied during heating, e.g., 0.1 MPa or more and 1.0 MPa or less. The shaped article can be cooled efficiently by applying a press pressure in the cooling step. In addition, when the press pressure in the cooling step is not excessively increased, it is possible to avoid excessively suppressing the shrinkage of the shaped article when cooled

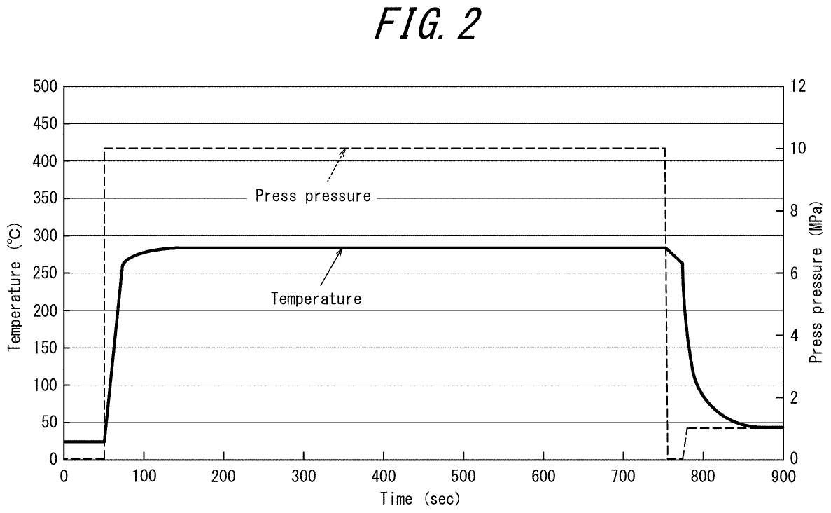

FIG. 2 depicts a temperature profile and a pressure profile when the crystallization step (2) is performed in Example 1 etc. which will be described later. In FIG. 2, at the same time as starting the application of a press pressure (10 MPa), the heating temperature is raised from room temperature to 280° C. abruptly (over about 50 seconds) and held at that temperature for a certain period of time (about 600 seconds), after which the temperature is slightly lowered by once releasing the press pressure, and at the same time as starting the application of a press pressure (1 MPa) again, the resin film and the like is cooled over 60 seconds to 100° C., a temperature below the resin's crystallization temperature of 130° C.

In the steps (0) to (2) described above, it is possible to effectively control the spherulite size and crystallinity. The shaped article obtained through the step (2) may be subjected to annealing as needed for the purpose of promoting crystallization, for example. Annealing refers to a treatment in which the cooled shaped article is heated again. The crystallinity and/or the spherulite size can be finely adjusted by annealing. Any annealing can be used and can be carried out for example using a heat treatment oven, an infrared heater, and the like.

(Prepreg)

The disclosed prepreg comprises a resin part and a base material adjacent to the resin part, wherein the resin part comprises a thermoplastic alicyclic structure-containing resin, the resin part has a crystallinity of 20% or more and 70% or less, and the resin part comprises a spherulite having a size of less than 3 μm. Because the disclosed prepreg has a crystallinity and a spherule size that fall within the respective ranges set forth above, it has excellent strength and heat resistance. In addition, the disclosed prepreg shows less dimensional changes due to heating and is excellent in dimensional accuracy.

<Resin part>

The resin part is a constituent composed of resin that is adjacent to the base material described later. The resin part may be a “layer” region that is adjacent to the base material. When the base material is a structure containing voids in the inside (e.g., when the base material is a fibrous base material), there is a case where the resin impregnates the voids. The phrase “resin impregnates the voids” refers to a state wherein the resin extends in such a way as to fill the voids. When the resin impregnates the voids, the resin part may extend over a “layer” region adjacent to the base material as well as over continuous or non-continuous partial regions present within the base material's voids. Depending on the balance of the volumes of the base material and the resin part used to form the prepreg, it may be difficult to confirm a “layer” region formed of the resin. However, even in the case where the resin part cannot be a “layer” when a certain prepreg is observed, the prepreg has a “resin part” as long as a resin component is present that is adjacent to the base material. From the viewpoint of enhancing the adhesion between the prepreg and an object to be bonded thereto, it is preferred that the resin part comprise a layer region that is adjacent to the base material.

As the “resin” for constituting the resin part, the resin detailed in the section (Shaped Article) above can be suitably used. In addition, the “resin” for constituting the resin part may optionally comprise additional components and additives described in detail in the section (Shaped Article) above in amounts that may fall within their preferred ranges described therein. The resin part comprises a spherulite of suitable size as described in the section «Spherulite of Resin» of <Shaped Article> above. Further, the resin part preferably exhibits a crystallinity that falls within the preferred range set forth in the section <Crystallinity of Shaped Article> of (Shaped Article) above.

<Base Material>

The base material is not particularly limited and examples thereof include synthetic resin fibers such as carbon fiber and cycloolefin resin fiber; and cloths or nonwoven fabrics made of glass or other material. When a cloth or non-woven fabric formed of a synthetic resin fiber such as a cyclic olefin resin fiber is used, the melting point of the synthetic resin fiber needs to be higher than the melting point of the resin for forming the resin part. A cloth or a nonwoven fabric made of glass is excellent from the viewpoint of heat resistance. On the other hand, when a cloth or non-woven fabric formed of a synthetic resin fiber is used, it is possible to form a prepreg having a low dielectric constant. The thickness of the base material is not particularly limited and may be, for example, 10 μm or more and 500 μm or less.

<Method of Manufacturing Prepreg>

When using for example the pre-shaped article described in the section <Step (1) of Obtaining Pre-Shaped Article> of (Method of Manufacturing Shaped Article)” above for the manufacture of a prepreg, a precursor of prepreg is obtained by stacking, in order, the pre-shaped article, the base material, and the pre-shaped article when performing heating and rapid cooling similar to those described in the section <Crystallization Step (2)> of (Method of Manufacturing Shaped Article) above. By vacuuming the atmosphere in which the precursor of prepreg to, for example, less than 100 kPa prior to the crystallization step, it is possible to favorably prevent air bubbles from remaining in the base material. By performing heating and rapid cooling similar to those described in the section <Crystallization Step (2)>of (Method of Manufacturing Shaped Article) above on the precursor of prepreg, it is possible to obtain a prepreg in which at least part of the resin component which has constituted the pre-shaped article impregnates the base material. The prepreg obtained by such a manufacturing method satisfies a predetermined attribute. Specifically, by performing the above step (2) on the precursor of prepreg, crystallization, formation of a spherulite of predetermined size, and impregnation of the base material with resin in the resin part contained in the prepreg can be performed in one step.

In place of the pre-shaped article, which is a shaped article prior to crystallization, the disclosed shaped article whose crystallinity and spherulite size satisfy the predetermined conditions can be used for manufacturing a prepreg. The prepreg can be obtained in the same manner as described above except that the shaped article is used instead of the pre-shaped article in the manufacturing method described above.

(Laminate)

The disclosed laminate comprises a resin layer and a metal layer laminated directly adjacent to at least one side of the resin layer. The resin layer comprises a thermoplastic alicyclic structure-containing resin, has a crystallinity of 20% or more and 70% or less, and comprises a spherulite having a size of less than 3 μm. Because the disclosed laminate comprises a resin layer having a crystallinity and spherulite size that fall within the respective ranges set forth above, it has excellent heat resistance and strength. The laminate is not particularly limited as long as it has at least one metal layer laminated directly adjacent to at least one surface of the resin layer. The laminate may have a metal layer laminated on both sides of the resin layer or may have a metal layer laminated only on one side of the resin layer.

<Metal Layer>

Examples of metal layers include layers which contain a metal such as copper, gold, silver, stainless steel, aluminum, nickel, or chromium. Among these metals, copper is preferred because a laminate can be obtained that is useful as a material for forming a printed circuit board. The thickness of the metal layer is not particularly limited and can be appropriately determined in accordance with the intended use of the laminate. The thickness of the metal layer may be usually 1 μm or more, and preferably 3 μm or more, but usually 35 μm or less, and preferably 18 μm or less.

<Resin Layer>

The resin layer is laminated directly adjacent to the metal layer. The term “directly adjacent” as used herein refers to a state in which the metal layer and the resin layer are directly in contact with each other without any other intervening layers such as an adhesive layer disposed between the metal layer and the resin layer. The resin layer may have a configuration similar to that of the shaped article or prepreg described above. In other words, the resin layer is required to have a crystallinity that falls within the predetermined range set forth above and to comprise a thermoplastic alicyclic structure-containing resin which comprises a spherulite having a size of less than 3 μm. Optionally, the resin layer may comprise the base material.

The resin layer can be formed using the pre-shaped article described in the section <Step (1) of Obtaining Pre-Shaped Article> of (Method of Manufacturing Shaped Article) above, the disclosed shaped article or the disclosed prepreg described. Accordingly, it is preferred that the “resin” for constituting the resin layer and attributes such as crystallinity and spherulite size in the resin layer satisfy the preferred attributes described above.

<Method of Manufacturing Laminate>

When for example the pre-shaped article described in the section <Step (1) of Obtaining Pre-Shaped Article> of (Method of Manufacturing Shaped Article) is to be used to manufacture the laminate, a stack is first obtained by stacking, in order, a metal foil, the pre-shaped article, the base material, the pre-shaped article, and a metal foil when performing heating and rapid cooling similar to those described in the section <Crystallization Step (2)> of (Method of Manufacturing Shaped Article). The metal foil is a material used to form a metal layer which is required to be disposed on either one of the sides of the laminate; the metal layer on the other side is optional. The preferred range for the thickness of the metal foil is the same as that set forth above for the metal layer. Heating and rapid cooling similar to those described in the section <Crystallization Step (2)> of (Method of Manufacturing Shaped Article) are then performed on the stack. The base material can be the same as that described above in the section <Base material> of (Prepreg).

(Multilayer Circuit Board)

The disclosed shaped article, prepreg and laminate can be suitably used in making a multilayer circuit board. When forming a multilayer circuit board, copper foil portions of a plurality of laminates are etched to form desired patterns, the prepreg(s) are interposed between the laminates to form a stack, and the stack is heat-pressed in the thickness direction. With this procedure, it is possible to efficiently manufacture a multilayer circuit board by causing the thermoplastic alicyclic structure-containing resin that constitute the prepreg to exert adhesion between adjacent surfaces of the laminates.

The multilayer circuit board formed using the disclosed shaped article, prepreg and/or laminate is excellent in strength and heat resistance as well as in insulating property in a high temperature range such as over 100° C. because the resin contained in the multilayer circuit board has a crystallinity that falls within the range set forth above and because the spherulite size is less than 3 μm.

### EXAMPLES

Hereinafter, the present disclosure will be specifically described with reference to Examples and Comparative Examples, which however shall not be construed as limiting the scope of the present disclosure. In the following description, “part(s)” representing quantities are based on mass unless otherwise specified. The pressure is a gauge pressure. Measurements and evaluations in each example were performed by the methods described below.

<Molecular Weight (Weight-Average Molecular Weight and Number-Average Molecular Weight) of Dicyclopentadiene Ring-Opened Polymer>

A solution of the dicyclopentadiene ring-opened polymer prepared below was collected for use as a measurement sample. For the measurement sample, the polystyrene-equivalent molecular weight of the dicyclopentadiene ring-opened polymer was measured on a gel permeation chromatography (GPC) system HLC-8320 (Tosoh Corporation Co., Ltd.) at 40° C. using a H-type column (Tosoh Corporation Co., Ltd.) with tetrahydrofuran used as solvent.

<Percent Hydrogenation (Hydrogenation Rate) of Alicyclic Structure-Containing Resin>

The percent hydrogenation of the thermoplastic alicyclic structure-containing resin prepared below was measured by ¹H-NMR spectroscopy at 145° C. with ortho-dichlorobenzene-d₄ as solvent.

<Proportion of Racemo Diad of Alicyclic Structure-Containing Resin>

The proportion of racemo diads (meso/racemo ratio) was determined by ¹³C-NMR spectroscopy with the inverse-gated decoupling method applied at 200° C. using 1:2 (by mass) mixed solvent of ortho-dichlorobenzene-d₄ and 1,2,4-trichlorobenzene (TCB)-d₃. Specifically, with a peak at 127.5 ppm derived from ortho-dichlorobenzene-d₄ as a reference shift, the proportion of racemo diads was determined based on the intensity ratio between the signal at 43.35 ppm derived from meso diads and the signal at 43.43 ppm derived from racemo diads.

<Melting Point, Glass-Transition Temperature, and Crystallization Temperature>

The prepared thermoplastic alicyclic structure-containing resin was measured for melting point, glass-transition temperature, and crystallization temperature using a differential scanning calorimeter (DSC6220, Hitachi High-Tech Science Corporation) at a heating rate 10° C./min.

<Crystallinity>

A specimen was cut out from each of the shaped articles manufactured in Examples and Comparative Examples. Note that for examples in which a product other than the shaped article was manufactured, crystallization treatment that is the same as in each example was performed without disposing a base material to provide a resin layer, and a specimen was cut out from the resin layer.

The specimen was placed in an X-ray diffractometer and measured in the 2θ range of 3° to 40°. The crystallinity value was calculated using the equation (crystal peak area)/(crystal peak area+broad pattern area)×100(%) with the peaks near 2θ=16.5° and 18.4° as crystal peaks and the broad pattern (halo pattern) as amorphous portion.

### <Spherulite Size>

A cross section of each of the shaped articles etc. manufactured in Examples and Comparative Examples was observed using an atomic force microscope. Spherulites present in the field of view were randomly selected and their size was measured directly from the viewing monitor. As to the size of a spherulite to be measured, the diameter of the circle that circumscribes the outline displayed on the viewing monitor was defined as the size of that spherulite. The maximum value of measured spherulite size was defined as the “spherulite size” of the shaped article measured.

<Tensile Strength and Elongation at Break>

The mechanical strength (tensile strength and elongation at break) of each of the shaped article etc. manufactured in Examples and Comparative Examples was measured on a tensile tester (AUTOGRAPH AGS-X, Shimadzu Corporation) using a measurement sample prepared as described below. Test was conducted on 5 sheets of the measurement sample and the average value was taken as the measurement value.

In preparing measurement samples, a sample of 10 mm width and 100 mm length was cut out from the shaped article. In the case of the laminate, a sample of 10 mm width and 100 mm length was cut out such that the longitudinal direction extends at an angle of 45° with respect to the cloth direction (texture direction) of the glass cloth (i.e., the direction in which the elasticity of the glass cloth can be most exhibited is the longitudinal direction of the sample).

<Reflow Resistance>

The shaped article etc. manufactured in Examples and Comparative Examples were each cut to make a 100 mm×100 mm measurement sample, and patterns for dimensional change measurement were provided at the four corners at intervals of 80 mm. The measured samples were subjected to a reflow test according to the profiles show in Table 1 as depicted in the drawings. For each sample, the distances between the patterns were measured, and dimensional changes before and after the reflow test were calculated using the equation: |dimensional change amount|/80 mm×100(%). When the dimensional change was 0.5% or less, the peak temperature in the profile of the corresponding reflow test was defined as the reflow resistance temperature.

<Dimensional Change>

Dimensional changes of the laminates manufactured in Examples and Comparative Examples were evaluated. First, portions of copper foil of the laminate of 250 mm×250 mm size were etched away to provide patterns for dimension change measurement at the four corners at intervals of 200 mm. After heat treatment at 150° C. for 30 minutes in an oven, the distances between the patterns were measured, and the dimensional change before and after heat treatment was calculated using the equation: |dimensional change amount|/200 mm×100(%). The value of dimensional change was calculated for the four sides. Table 1 shows a threshold satisfied by all of the values calculated for the four sides.

<Insulation Resistance Value>

The shaped article etc. manufactured in Examples and Comparative Examples were measured for insulation resistance in thickness direction. Voltage was 500V and the measurement temperature range was 25° C. to 125° C.

### Example 1

### Synthesis of Thermoplastic Alicyclic Structure-Containing Resin (COP1)

As a thermoplastic alicyclic structure-containing resin (COP1), a hydrogenated dicyclopentadiene ring-opened polymer was obtained according to the following procedure.

To a metallic pressure-resistant reactor purged with nitrogen were added 154.5 parts of cyclohexane, 42.8 parts of a solution of 70% dicyclopentadiene (≥99% endo content) in cyclohexane (equivalent to 30 parts of dicyclopentadiene) and 1.9 parts of 1-hexene, and the entire mass was heated to 53° C.

To a solution obtained by dissolving 0.014 parts of a tetrachlorotungsten phenylimide (tetrahydrofuran) complex in 0.70 parts of toluene, 0.061 parts of a solution of 19% diethylaluminum ethoxide in n-hexane was added and stirred for 10 minutes to prepare a catalyst solution. The catalyst solution was added into the reactor to initiate a ring-opening polymerization reaction.

After stirring the entire mass for 270 minutes while maintaining the temperature at 55° C., 1.5 parts of methanol was added to quench the ring-opening polymerization reaction. Addition of methanol to the polymerization reaction solution also results in an effect of insolubilizing the catalyst component.

The dicyclopentadiene ring-opened polymer contained in the obtained polymerization reaction solution had a weight-average molecular weight (Mw) of 28,700 and a number-average molecular weight (Mn) of 9,570, with the molecular weight distribution (Mw/Mn) being 3.0.

To the obtained polymerization reaction solution, 1 part of diatomite (Radiolite #1500, Showa Chemical Industry Co., Ltd.) was added as a filter aid. The suspension was passed through a leaf filter (CFR2, IHI Corporation) to filter off the insolubilized catalyst component together with diatomite to afford a dicyclopentadiene ring-opened polymer solution.

After transferring the dicyclopentadiene ring-opened polymer solution obtained above to a reactor (manufactured by Sumitomo Heavy Industries, Ltd.) fitted with a stirred and a temperature control jacket, 600 parts of cyclohexane and 0.1 parts of chlorohydridocarbonyltris(triphenylphosphine) ruthenium were added so that the concentration of the dicyclopentadiene ring-opened polymer became 9%. Hydrogenation reaction was then carried out under 4 MPa hydrogen pressure at 180° C. for 6 hours while stirring the entire mass at 64 rpm to afford a slurry containing hydrogenated dicyclopentadiene ring-opened polymer particles.

By centrifuging the slurry thus obtained, solids were isolated and dried under reduced pressure at 60° C. for 24 hours to afford 27.0 parts of the hydrogenated dicyclopentadiene ring-opened polymer as a thermoplastic alicyclic structure-containing resin.

The thermoplastic alicyclic structure-containing resin had a percent hydrogenation of unsaturated bonds by the hydrogenation reaction of 99% or more, a glass-transition temperature of 98° C., a melting point of 262° C., a crystallization temperature of 130° C., and a racemo diad proportion (i.e., syndiotacticity) of 90%.

<Manufacture of Shaped Article>

### «Step (0) of Obtaining Resin Pellets»

After mixing 100 parts of the hydrogenated dicyclopentadiene ring-opened polymer with 0.8 parts of an antioxidant (tetrakis [methylene-3-(3′,5′-di-t-butyl-4′-hydroxyphenyl)propionate]methane, “Irganox 1010” (Irganox is a registered trade mark in Japan, other countries, or both), BASF Japan Ltd.), the mixture was put into a twin-screw extruder (TEM-37B, Toshiba Machine Co., Ltd.) and extruded into a strand as a shaped article by hot melt extrusion molding. The strand was then cut into resin pellets by a strand cutter. The operating conditions of the twin-screw extruder are shown below.
Barrel temperature setting: 270° C. to 280° C.
Die temperature setting: 250° C.
Screw rotation speed: 145 rpm
Feeder rotation speed: 50 rpm

### «Step (1) of Obtaining Pre-Shaped Article»

The resin pellets obtained in the step (0) were subjected to shape forming under the following conditions to afford a resin film as a pre-shaped article in film form having a thickness of 100 μm.
Molding machine: hot-melt extrusion film making machine equipped with a T die (Measuring Extruder Type Me-20/2800V3, Optical Control Systems GmbH)
Barrel temperature setting: 280° C. to 290° C.
Die temperature: 270° C.
Screw rotation speed : 30 rpm
Film take-up rate: 1 m/min

### «Crystallization Step (2)»

From the resin film obtained in the step (1), a sheet of 250 mm×250 mm size was cut out, pressed for 10 minutes using a vacuum laminator (dry laminator SDL380-280-100-H, Nikkiso Co., Ltd.) under 10 MPa pressure at 280° C. and rapidly cooled in accordance with the profiles depicted in FIG. 2 to afford a shaped article having a sheet shape. As shown in the temperature profile depicted in FIG. 2, at the time of rapid cooling, the time from 262° C. (melting point) to 100° C. (temperature below the crystallization temperature) was set to not greater than 30 seconds.

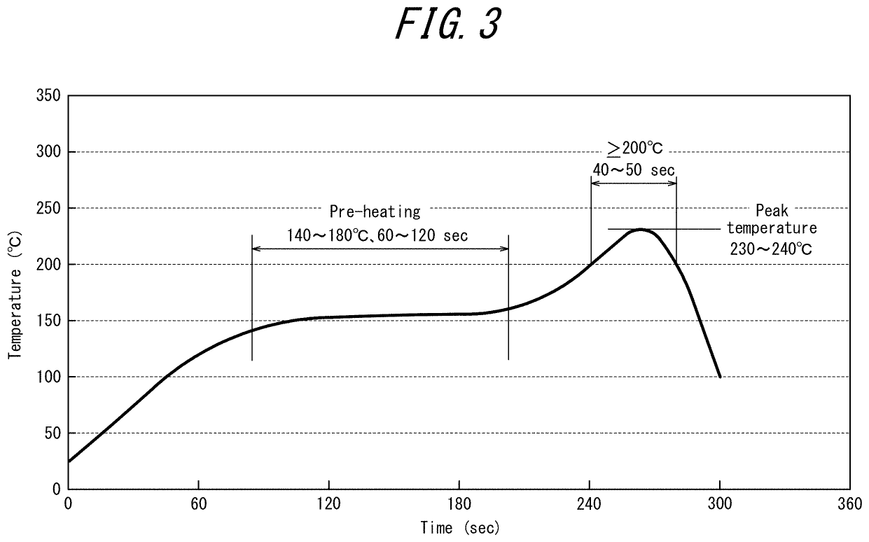

The obtained shaped article was evaluated for the items shown in Table 1 in accordance with the methods described above. When evaluating reflow resistance, the reflow test described above was carried out in accordance with the temperature profile depicted in FIG. 3.

The insulation resistance in thickness direction of the shaped article as measured by the method described above was 10⁵ MS2 from 25° C. to 125° C.

### Example 2

### Synthesis of Thermoplastic Alicyclic Structure-Containing Resin (COP2)

As a thermoplastic alicyclic structure-containing resin (COP2), a hydrogenated dicyclopentadiene ring-opened polymer was obtained according to the following procedure.

To a metallic pressure-resistant reactor purged with nitrogen were added 344 parts of toluene, 286 parts of a solution of 35% dicyclopentadiene (≥_99% endo content) in toluene (equivalent to 100 parts of dicyclopentadiene) and 8 parts of 1-hexene, and the entire mass was heated to 35° C.

0.086 parts of tungsten complex as a ring-opening polymerization catalyst was dissolved into 29 parts of toluene to prepare a catalyst solution. The catalyst solution was added into the reactor and a ring-opening polymerization reaction was carried out at 35° C. for 1 hour to afford a solution containing a dicyclopentadiene ring-opened polymer.

To 667 parts of the obtained dicyclopentadiene ring-opened polymer solution was added 1.1 parts of 2-propanol as a terminator to quench the polymerization reaction.

A portion of this solution was used to measure the molecular weight of the dicyclopentadiene ring-opened polymer. The polymer had a weight-average molecular weight (Mw) of 24,600 and a number-average molecular weight (Mn) of 8,600, with the molecular weight distribution (Mw/Mn) of 2.86.

After transferring the dicyclopentadiene ring-opened polymer solution obtained above to a metallic pressure-resistant reactor fitted with a stirred and a temperature control jacket, 330 parts of toluene and 0.027 parts of chlorohydridocarbonyltris(triphenylphosphine) ruthenium as a hydrogenation catalyst were added. While stirring the entire mass at 64 rpm, the hydrogen pressure was raised to 2.0 MPa and the temperature to 120° C., and the hydrogen pressure was further raised to 2.0 MPa at a rate of 0.03 MPa/min and the temperature to 180° C. at a rate of 1° C./min, followed by a hydrogenation reaction for 6 hours. The reaction liquid after cooling was a slurry with precipitated solids.

By centrifuging the reaction liquid, solids were isolated and dried under reduced pressure at 120° C. for 24 hours to afford 90 parts of a hydrogenated dicyclopentadiene ring-opened polymer as a thermoplastic alicyclic structure-containing resin.

The thermoplastic alicyclic structure-containing resin had a percent hydrogenation of 99.5%, a melting point of 276° C., and a racemo diad proportion (i.e., syndiotacticity) of 100%. Using a differential scanning calorimeter (DSC), the obtained hydrogenated dicyclopentadiene ring-opened polymer was also confirmed to have a glass-transition temperature of 90° C. or higher and 120° C. or lower, and a crystallization temperature of 120° C.

<Manufacture of Shaped Article>

### «Step (0) of Obtaining Resin Pellets»

After mixing 20 parts of the hydrogenated dicyclopentadiene ring-opened polymer with 0.16 parts of an antioxidant (tetrakis[methylene-3-(3′,5′-di-t-butyl-4′-hydroxyphenyl)propionate]methane, “Irganox 1010” (Irganox is a registered trade mark in Japan, other countries, or both), BASF Japan Ltd.), the mixture was put into a twin-screw extruder (TEM-37B, Toshiba Machine Co., Ltd.) and extruded into a strand by hot melt extrusion molding. By a strand cutter the strand was then cut into pellets, a resin material containing the hydrogenated dicyclopentadiene ring-opened polymer.

The operating conditions of the twin-screw extruder are shown below.
Barrel temperature setting: 280° C. to 290° C.
Die temperature setting: 260° C.
Screw rotation speed: 145 rpm
Feeder rotation speed: 50 rpm

### «Step (1) of Obtaining Pre-Shaped Article»

The resin pellets obtained in the step (0) were subjected to shape forming under the following conditions to afford a resin film as a pre-shaped article in film form having a thickness of 100 μm.
Molding machine: hot-melt extrusion film making machine equipped with a T die (Measuring Extruder Type Me-20/2800V3, Optical Control Systems GmbH)
Barrel temperature setting: 290° C. to 300° C.
Die temperature: 280° C.
Screw rotation speed: 35 rpm
Film take-up rate: 1 m/min
   «Crystallization step (2)»

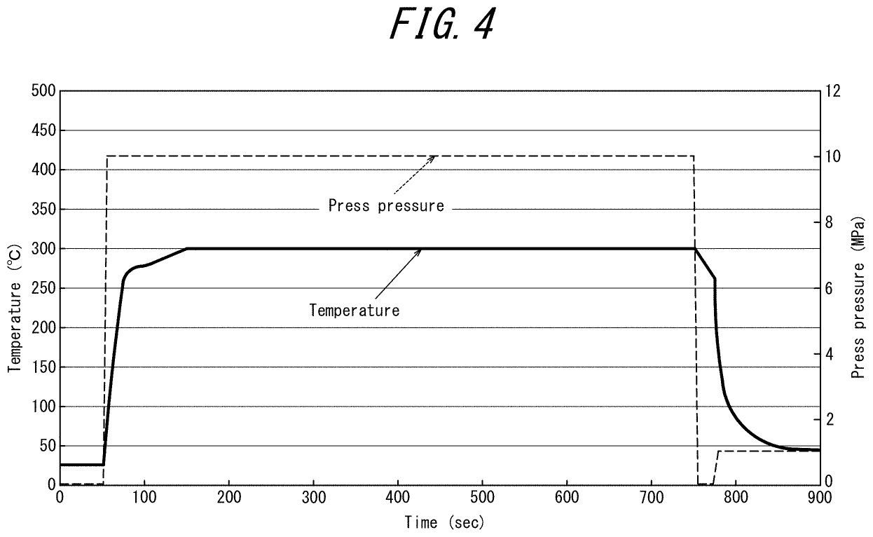

From the film shaped article obtained in the step (1), a sheet of 250 mm×250 mm size was cut out, pressed for 10 minutes using a vacuum laminator (dry laminator SDL380-280-100-H, Nikkiso Co., Ltd.) under 10 MPa pressure at 300° C. and rapidly cooled in accordance with the profiles depicted in FIG. 4.

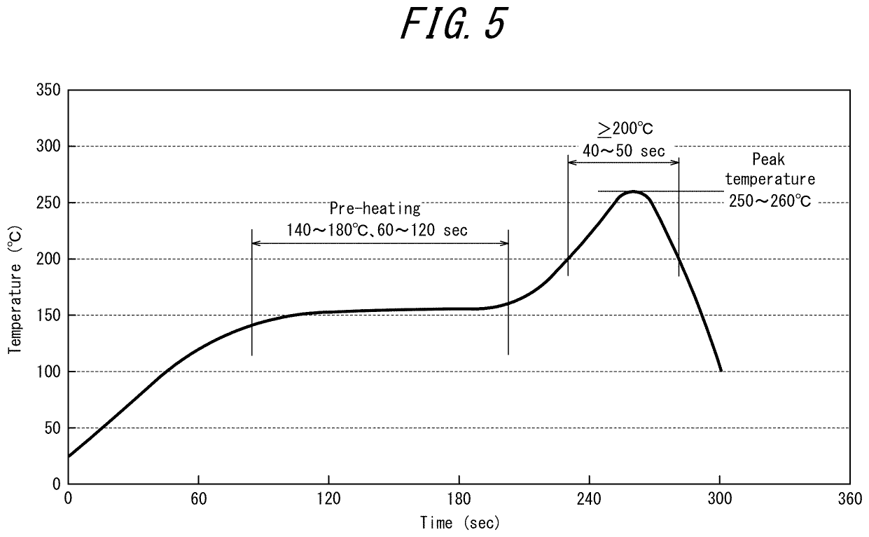

The obtained shaped article was evaluated for the items shown in Table 1 in accordance with the methods described above. When evaluating reflow resistance, the reflow test described above was carried out in accordance with the temperature profile depicted in FIG. 5.

### Example 3

A resin film (film-shaped pre-shaped article prior to crystallization) was obtained by the same process as in Example 1. Two resin sheets of 250 mm×250 mm size were cut out from the resin film, a glass cloth (E-glass 1078, Nitto Boseki Co., Ltd.) cut out to 250 mm×250 mm size was sandwiched between the resin sheets, and copper foil (CF-T4X-SV, Fukuda Metal Foil & Powder, Co., Ltd., thickness: 18 μm, Rz: 1.0 μm) was placed on the outside of each resin sheet. The stack thus obtained was pressed using a vacuum laminator (dry laminator SDL380-280-100-H, Nikkiso Co., Ltd.) for 10 minutes at 280° C. under 10 MPa pressure and rapidly cooled in accordance with the profiles depicted in FIG. 2 to manufacture a double-sided copper clad laminate.

The laminate obtained as described above was evaluated for the items shown in Table 1 in accordance with the methods described above. When evaluating reflow resistance, the reflow test described above was carried out in accordance with the temperature profile depicted in FIG. 3.

### Example 4

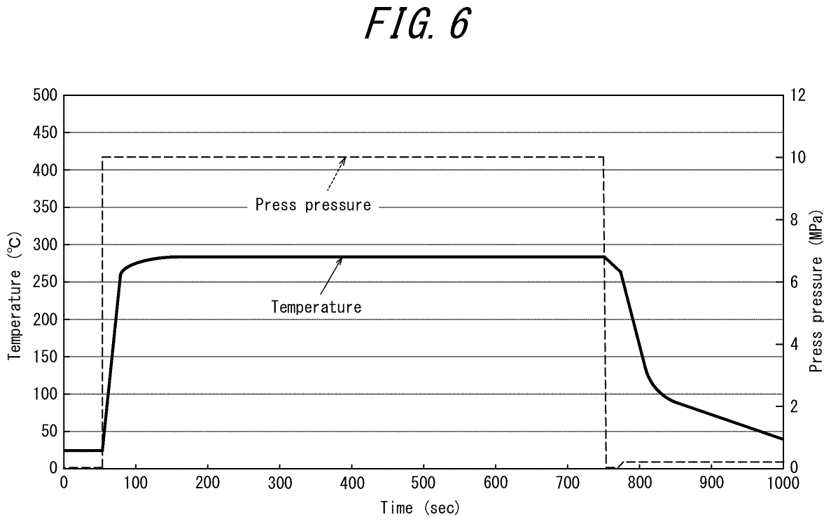

A resin film (film-shaped pre-shaped article prior to crystallization) was obtained by the same process as in Example 1. Two resin sheets of 250 mm×250 mm size were cut out from the resin film, a glass cloth (E-glass 1078, Nitto Boseki Co., Ltd.) cut out to 250 mm×250 mm size was sandwiched between the resin sheets, and copper foil (CF-T4X-SV, Fukuda Metal Foil & Powder, Co., Ltd., thickness: 18 μm, Rz: 1.0 μm) was placed on the outside of each resin sheet. The stack thus obtained was pressed using a vacuum laminator (SDL380-280-100-H, Nikkiso Co., Ltd.) for 10 minutes at 280° C. under 10 MPa pressure and rapidly cooled in accordance with the profiles depicted in FIG. 6 to manufacture a double-sided copper clad laminate. As depicted in FIG. 6, the temperature profile at the time of rapid cooling was such that the time from 262° C. (melting point) to 150° C. was 30 seconds and the time from 150° C. to 100° C. (temperature below crystallization temperature) was not greater than 30 seconds.

The laminate obtained as described above was evaluated for the items shown in Table 1 in accordance with the methods described above. When evaluating reflow resistance, the reflow test described above was carried out in accordance with the temperature profile depicted in FIG. 3.

### Example 5

A resin film (film-shaped pre-shaped article prior to crystallization) was obtained by the same process as in Example 1. Two resin sheets of 250 mm×250 mm size were cut out from the resin film, and a glass cloth (E-glass 1078, Nitto Boseki Co., Ltd.) cut out to 250 mm×250 mm size was sandwiched between the resin sheets. The stack thus obtained was pressed using a vacuum laminator (dry laminator SDL380-280-100-H, Nikkiso Co., Ltd.) for 10 minutes at 280° C. under 10 MPa pressure and rapidly cooled in accordance with the profiles depicted in FIG. 2 to manufacture a prepreg.

The prepreg obtained as described above was evaluated for the items shown in Table 1 other than dielectric constant and dielectric lass in accordance with the methods described above. When evaluating reflow resistance, the reflow test described above was carried out in accordance with the temperature profile depicted in FIG. 3.

A double-sided copper clad laminate was manufactured by the same process as in Example 3.

Portions of copper foil of the copper clad laminate were etched away to form predetermined interconnection patterns. The copper clad laminate with interconnection patterns and the prepreg were placed atop each other and again pressed by a vacuum laminator (dry laminator SDL380-280-100-H, Nikkiso Co., Ltd.). The profiles depicted in FIG. 2 were used.

A multilayer circuit board was obtained by the process described above. After etching away copper foil from the prepreg and the copper clad laminate, the multilayer circuit board was cut out to 50 mm×50 mm size to prepare a test sample. The test sample was measured for dielectric properties by the balanced circular disk resonator method. A network analyzer (PNA-Network Analyzer N5227, Agilent Technologies) was used for the measurements. Relative permittivity εᵣ at 10 GHz was 2.53 and dielectric loss tans was 0.0008. Thus, the resulting multilayer circuit board had a low dielectric constant and a low dielectric loss, revealing that it can be suitably disposed in an electronic device that uses high-speed transmission signals or high-frequency signals.

### Comparative Example 1

A resin film (film-shaped pre-shaped article prior to crystallization) was obtained by the same process as in Example 1. The resin film was evaluated for the items shown in Table 1 in accordance with the methods described above. When evaluating reflow resistance, the reflow test described above was carried out in accordance with the profile depicted in FIG. 3.

### Comparative Example 2

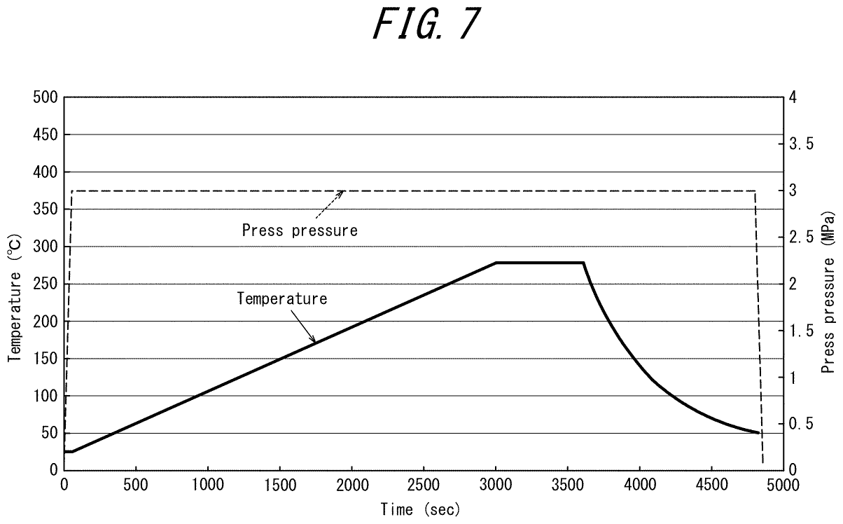

A resin film (film-shaped pre-shaped article prior to crystallization) was obtained by the same process as in Example 1. A sheet of 250 mm×250 mm size was cut out from the resin film. Using a vacuum hot press machine (Model IMC-182, Imoto machinery Co., Ltd.), the resin film was pressed for 10 minutes under 3 MPa pressure at 280° C. and then slowly cooled in accordance with the profiles shown in FIG. 7 to afford a shaped article having a film shape.

The shaped article thus obtained was evaluated for the items shown in Table 1 in accordance with the methods described above.

### Comparative Example 3

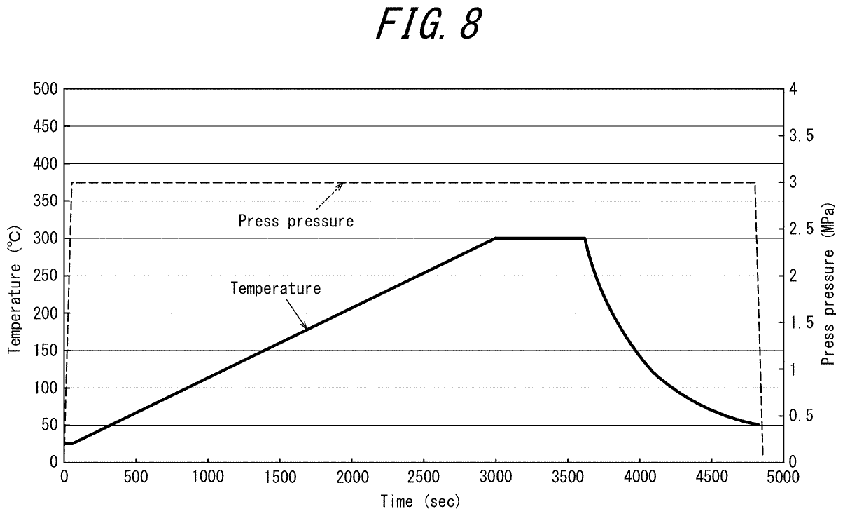

A resin film (film-shaped pre-shaped article prior to crystallization) was obtained by the same process as in Example 2. A sheet of 250 mm×250 mm size was cut out from the resin film. Using a vacuum hot press machine (Model IMC-182, Imoto machinery Co., Ltd.), the resin film was pressed for 10 minutes under 3 MPa pressure at 280° C. and then slowly cooled in accordance with the profiles shown in FIG. 8 to afford a shaped article having a film shape.

The shaped article thus obtained was evaluated for the items shown in Table 1 in accordance with the methods described above.

### Comparative Example 4

A resin film (film-shaped pre-shaped article prior to crystallization) was obtained by the same process as in Example 1. Two resin sheets of 250 mm×250 mm size were cut out from the resin film. Copper foil (CF-T4X-SV, Fukuda Metal Foil & Powder, Co., Ltd., thickness: 18 μm, Rz: 1.0 μm) cut out to 250 mm×250 mm size was placed on the outside of each resin sheet. Using a vacuum hot press machine (Model IMC-182, Imoto machinery Co., Ltd.), the stack thus obtained was pressed for 10 minutes under 3 MPa pressure at 280° C. and then slowly cooled in accordance with the profiles shown in FIG. 7 to afford a double-sided copper clad laminate.

The laminate thus obtained was evaluated for the items shown in Table 1 in accordance with the methods described above.

TABLE 1

| | | | Examples | | | | |
|---|---|---|---|---|---|---|---|
| | | | 1 | 2 | 3 | 4 | 5 |
| Type | | | Shaped | Shaped | Laminate | Laminate | Laminate |
| | | | article | article | (copper clad | (copper clad | (multilayer |
| | | | | | laminate) | laminate) | circuit board) |
| Structure | | | — | — | Metal layer/Resin | Metal layer/Resin | Copper clad |
| | | | | | layer (including base | layer (including base | laminate of |
| | | | | | material)/Metal layer | material)/Metal layer | Example 3/Prepreg |
| Thermoplastic | Type | | COP1 | COP2 | COP1 | COP1 | COP1 |
| resin | Melting point (° C.) | | 262 | 276 | 262 | 262 | 262 |
| | Crystallization temperature (° C.) | | 130 | 120 | 130 | 130 | 130 |
| Base material | | | — | — | Glass cloth | Glass cloth | Glass cloth |
| Crystallization | Performed/Not performed | | Performed | Performed | Performed | Performed | Performed |
| treatment | Profile | | FIG. 2 | FIG. 4 | FIG. 2 | FIG. 6 | FIG. 2 |
| | Cooling time from melting point | | ≤30 sec | ≤30 sec | ≤30 sec | ≤1 min | ≤30 sec |
| | to crystallization temperature | | | | | | |
| Evaluations | Crystallinity (%) | | 40 | 70 | 40 | 50 | 40 |
| | Spherulite size (μm) | | 1 | 1 | 1 | 2 | 1 |
| | Tensile strength (MPa) | | 60 | 65 | 95 | 95 | 95 |
| | Elongation at break (%) | | 200 | 200 | — | — | — |
| | Reflow | Profile | FIG. 3 | FIG. 5 | FIG. 3 | FIG. 3 | FIG. 3 |
| | resistance | Temperature | 230 | 260 | 230 | 240 | 230 |
| | | (° C.) | | | | | |
| | Dimensional change | | ≤0.5% | ≤0.5% | ≤0.1% | ≤0.1% | — |
| | Insulation resistance | 25° C. | 10⁵ | — | — | — | — |
| | value (MΩ) | 125° C. | 10⁵ | — | — | — | — |

| | | | | | |
|---|---|---|---|---|---|
| Relative permittity @10 GHz(—) | — | — | — | — | 2.53 |
| Dielectric loss @10 GHz(—) | — | — | — | — | 0.0008 |

| | | Comparative Examples | | | |
|---|---|---|---|---|---|
| | | 1 | 2 | 3 | 4 |
| Type | | Shaped | Shaped | Shaped | Laminate |
| | | article | article | article | |
| Structure | | — | — | — | Metal layer/Resin |
| | | | | | layer/Resin layer/ |
| | | | | | Metal layer |
| Thermoplastic | Type | COP1 | COP1 | COP2 | COP1 |
| resin | Melting point (° C.) | 262 | 262 | 276 | 262 |
| | Crystallization temperature (° C.) | 130 | 130 | 120 | 130 |
| Base material | | — | — | — | — |
| Crystallization | Performed/Not performed | Not performed | Performed | Performed | Performed |
| treatment | Profile | — | FIG. 7 | FIG. 8 | FIG. 7 |
| | Cooling time from melting point | — | >1 min | >1 min | >1 min |
| | to crystallization temperature | | | | |
| Evaluations | Crystallinity (%) | 15 | 50 | 75 | 50 |
| | Spherulite size (μm) | No | ≥3 | ≥3 | ≥3 |
| | | spherulite | | | |
| | Tensile strength (MPa) | — | 30 | 30 | 30 |
| | Elongation at break (%) | — | 17 | 17 | 17 |

| Reflow | Profile | FIG. 3 | — | — | — |
|---|---|---|---|---|---|
| resistance | Temperature | <230 | — | — | — |
| | (° C.) | | | | |
| Dimensional change | | >0.5% | — | — | 1%≤ |
| Insulation resistance | 25° C. | 10⁵ | — | — | — |
| value (MΩ) | 125° C. | 10⁴ | — | — | — |

| | | | | |
|---|---|---|---|---|
| Relative permittity @10 GHz(—) | — | — | — | — |
| Dielectric loss @10 GHz(—) | — | — | — | — |

As evident from Table 1, the shaped articles of Examples 1 and 2 which comprise a spherulite of an alicyclic structure-containing resin with a size of less than 3 μm and which have a crystallinity of 20% or more and 70% or less, the laminates (copper clad laminates) of Examples 3 and 4 comprising the shaped article, and the laminate (multilayer circuit board) of Example 5 where the crystallinity of the resin part and the spherulite size meet the above requirements are all excellent in heat resistance and strength. In contrast, it is evident that Comparative 1 where the crystallinity is less than 20% and Comparative Examples 2 to 4 where the spherulite size is not less than 3 μm failed to achieve both heat resistance and strength.

### INDUSTRIAL APPLICABILITY

According to the present disclosure, it is possible to provide a shaped article comprising a thermoplastic resin excellent in heat resistance and strength, and a method for producing the same.

Further, according to the present disclosure, it is possible to provide a prepreg containing a thermoplastic resin excellent in heat resistance and strength.

Further, according to the present disclosure, it is possible to provide a laminate comprising a resin layer made of a thermoplastic resin excellent in heat resistance and strength.

1. A shaped article comprising a thermoplastic alicyclic structure-containing resin,
wherein the shaped article comprises a spherulite having a size of less than 3 μm and has a crystallinity of 20% or more and 70% or less.

2. The shaped article according to claim 1, wherein the thermoplastic alicyclic structure-containing resin has a melting point of 200° C. or higher.

3. The shaped article according to claim 1, further comprising at least one of a filler, a flame retardant, and an antioxidant.

4. A prepreg comprising a resin part and a base material adjacent to the resin part,
wherein the resin part comprises a thermoplastic alicyclic structure-containing resin,
the resin part has a crystallinity of 20% or more and 70% or less, and
the resin part comprises a spherulite having a size of less than 3 μm.

5. The prepreg according to claim 4, wherein the thermoplastic alicyclic structure-containing resin has a melting point of 200° C. or higher.

6. The prepreg according to claim 4, wherein the resin part further comprises at least one of a filler, a flame retardant, and an antioxidant.

7. A laminate comprising a resin layer and a metal layer laminated directly adjacent to at least one side of the resin layer,
wherein the resin layer comprises a thermoplastic alicyclic structure-containing resin,
the resin layer has a crystallinity of 20% or more and 70% or less, and
the resin layer comprises a spherulite having a size of less than 3 μm.

8. The laminate according to claim 7, wherein the resin layer further comprises at least one of a filler, a flame retardant, and an antioxidant.

9. A method of manufacturing the shaped article according to claim 1, comprising a crystallization step wherein a pre-shaped article comprising a thermoplastic alicyclic structure-containing resin is heat-pressed at a temperature equal to or higher than a melting point Tm (° C.) of the thermoplastic alicyclic structure-containing resin and then rapidly cooled to a crystallization temperature Tc (° C.) of the thermoplastic alicyclic structure-containing resin to crystallize the thermoplastic alicyclic structure-containing resin.

10. The method according to claim 9, wherein a cooling time from the melting point Tm (° C.) to the crystallization temperature Tc (° C.) upon rapid cooling in the crystallization step is 1 minute or less.
